(19) United States
(12) Patent Application Publication
(10) Pub. No.: US 2023/0161778 A1
(43) Pub. Date: May 25, 2023

(54) PROVIDING CONTACT INFORMATION AND CONNECTION HISTORY WITH COLLABORATION APPLICATIONS

(71) Applicant: Citrix Systems, Inc., Ft. Lauderdale, FL (US)

(72) Inventors: Zongpeng Qiao, Nanjing (CN); Ke Xu, Nanjing (CN); Shutian Yao, Nanjing (CN); Kun Li, Nanjing (CN)

(73) Assignee: Citrix Systems, Inc., Ft. Lauderdale, FL (US)

(21) Appl. No.: 17/647,292

(22) Filed: Jan. 6, 2022

Related U.S. Application Data
(63) Continuation of application No. PCT/CN2021/132382, filed on Nov. 23, 2021.

(51) Int. Cl. G06F 16/2457

(52) U.S. Cl. CPC G06F 16/24578

(57) ABSTRACT

A computer system configured to generate a user contact profile is provided. The computer system includes a memory and at least one processor coupled to the memory. The at least one processor is configured to receive, from a client device, a search request specifying a user contact; retrieve connection data involving the user contact from one or more collaboration services via one or more application programming interfaces (APIs); summarize the connection data to obtain a connection summary; retrieve, from a data store, usage data of one or more communication applications by the user contact; rank the usage data of the one or more communication applications to obtain a usage ranking; and send the connection summary and the usage ranking to the client device to be rendered.

### CROSS-REFERENCE TO RELATED APPLICATION

This application claims priority under 35 U.S.C. § 120 as a continuation of PCT Application No. PCT/CN2021/132382, titled “PROVIDING CONTACT INFORMATION AND CONNECTION HISTORY WITH COLLABORATION APPLICATIONS” and filed Nov. 23, 2021. PCT Application No. PCT/CN2021/132382 is hereby incorporated herein by reference in its entirety.

### BACKGROUND

Online communication and collaboration have become indispensable in the workplace, particularly for remote workers or for those collaborating from branch offices in different geographic locations. For example, email, messaging applications, voice over IP (VoIP), and video meeting applications have become crucial parts of workers' toolkits. At the same time, the number and types of such communication and collaboration applications have proliferated, posing additional challenges for smooth, efficient workflow and seamless communication.

### SUMMARY

In at least one example, a client computer system is provided. The client computer system includes a memory and at least one processor coupled to the memory. The at least one processor is configured to receive, from a client device, a search request specifying a user contact. The at least one processor is further configured to retrieve connection data involving the user contact from one or more collaboration services via one or more application programming interfaces (APIs). The at least one processor is further configured to summarize the connection data to obtain a connection summary. The at least one processor is further configured to retrieve, from a data store, usage data of one or more communication applications by the user contact. The at least one processor is further configured to rank the usage data of the one or more communication applications to obtain a usage ranking. The at least one processor is further configured to send the connection summary and the usage ranking to the client device to be rendered.

At least some examples of the client computer system can include one or more of the following features. In the system, the one or more communication applications can comprise a plurality of communication applications.

In the system, the plurality of communication applications can pertain to a plurality of types of communication applications. The plurality of types can include: applications configured to transmit chat messages comprising text; applications configured to transmit voice and/or video; and applications configured to transmit electronic mail. To rank the usage data of the one or more communication applications can comprise to rank a respective set of communication applications pertaining to a respective type of the communication applications.

In the system, to rank the usage data of the one or more communication applications can comprise to rank the one or more communication applications by a frequency of usage by the user contact.

In the system, to summarize the connection data can comprise to perform a term frequency-inverse document frequency (TF-IDF) analysis.

In the system, to summarize the connection data further can comprise to compute a phrase score for a respective phrase in the connection data based on a sum of TF-IDF values for a plurality of terms in the respective phrase. To summarize the connection data can further comprise to generate the connection summary including at least a first phrase having a first phrase score above a threshold value.

In the system, to summarize the connection data comprises to map, based on a natural language processing model, the connection data to the connection summary.

In the system, the at least one processor can be further configured to retrieve, from a second client device, updated usage data specifying a number of usages by the user contact of a respective communication application during a recent time period. The at least one processor can be further configured to update the usage data in the data store to include the updated usage data.

In the system, the connection data can include one or more historical conversations of the user contact utilizing the one or more collaboration services.

In the system, a respective collaboration service of the one or more collaboration services can be associated with a respective communication application.

In at least one example, a method is provided. The method includes acts of receiving, from a client device by a server, a search request specifying a user contact, retrieving connection data associated with the user contact from one or more collaboration services via one or more APIs, summarizing the connection data to obtain a connection summary, retrieving, from a data store, usage data specifying usage by the user contact of one or more communication applications, ranking the usage data of the one or more communication applications to obtain a usage ranking, and sending the connection summary and the usage ranking to the client device, wherein the client device renders the connection summary and the usage ranking.

At least some examples are directed to a non-transitory computer readable medium storing executable instructions. In these examples, the instructions can be encoded to execute any of the acts of the method of generating a user contact profile described above.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 illustrates an example virtualized workspace of an overworked technology manager.

FIG. 2 illustrates a user contact's profile including a contact's information, a connection history with the contact, and a ranking of the contact's usage frequency of a plurality of communication applications, in accordance with an example of the present disclosure.

FIG. 3 is a block diagram illustrating a system to generate a user contact profile, in accordance with an example of the present disclosure.

FIG. 4 is a communication flow diagram illustrating a system to generate a user contact profile, in accordance with an example of the present disclosure.

FIG. 5 is a flow diagram of a process for generating a user contact profile, in accordance with an example of the present disclosure.

FIG. 6A is a flow diagram of a process for using term frequency-inverse document frequency (TF-IDF) analysis to generate a user contact profile, in accordance with an example of the present disclosure.

FIG. 6B is a flow diagram of a process for using natural language processing (NLP) to generate a user contact profile, in accordance with an example of the present disclosure.

FIG. 7 is a block diagram of an example system for generating a user contact profile, in accordance with an example of the present disclosure.

FIG. 8 is a block diagram of a computing device configured to implement various systems and processes in accordance with examples disclosed herein.

### DETAILED DESCRIPTION

As summarized above, various examples described herein are directed to systems and methods to generate a contact profile. The contact profile can include information about a contact, such as the contact's name, title, address, supervisor, and the like. The profile can also include a user's connection history with the contact, and a ranking of the contact's usage frequency of a plurality of communication applications.

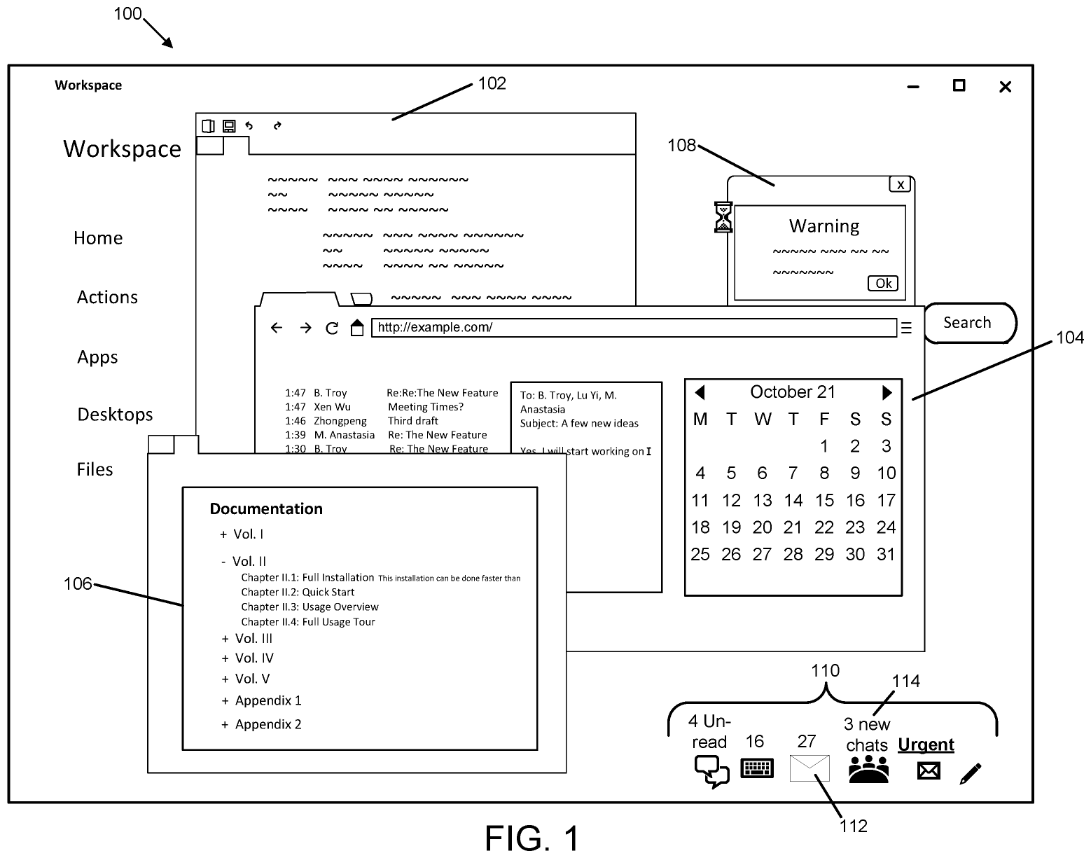

FIG. 1 illustrates an example virtualized workspace 100 of an overworked technology manager. In this example, the workspace 100 includes an incomplete programming project 102, an overflowing email inbox 104, an open table of contents for a voluminous software manual 106, and a warning dialog 108 indicating a technical problem.

Due to the overworked technology manager's time constraints and many responsibilities, the overworked technology manager is unable to respond to all of the technology manager's received emails 104, as well as to messages from the many different communication applications 110 featured in the workspace 100. For example, the overworked technology manager may have a preference or a habit for using certain ones of the communication applications 110, and may accordingly be more likely to check these applications more frequently than others. For example, the icon 112 shows 27 unread messages, while the icon 114 shows only 3 unread chats.

Accordingly, another user trying to reach the overworked technology manager may wish to use the application 114 to reach the overworked technology manager, since the overworked technology manager may check the application 114 more frequently, and hence the application 114 is far likelier to reach the overworked technology manager sooner. By the same token, the overworked technology manager may also wish to write messages to another colleague using the application that is most likely to reach the colleague soonest, given that the overworked technology manager has many time constraints and seeks to receive a response to his or her queries as soon as possible.

Thus, there is a need for informed recommendations of an appropriate method of contact to reach another user. The disclosed system and methods can address this need by supplying a custom contact profile for contacts, such as business colleagues (e.g., the overworked technology manager of the example of FIG. 1) or acquaintances, searched for by a user. The user can use the disclosed contact profile to judge how and when to contact another user. For example, the user can determine one or more specific applications to which another user is most likely to respond (e.g., the application 114 of the example of FIG. 1). Likewise, the user can use the disclosed contact profile to find pertinent context from previous conversations and to decide what topics to discuss, as well as how to raise those conversation topics.

In some examples, the disclosed system and methods for generating a custom contact profile can boost user collaboration efficiency, irrespective of whether the searched contact is overworked. For example, there are many reasons why user contacts may be likeliest to respond to certain communication applications and contact methods. In some cases, user contacts may be likeliest to use certain applications that they personally prefer, or with which they are most familiar. In other cases, user contacts may be likeliest to use applications that are popular among their own collaborators, or that are more widely used within their organization. For example, some organizations may preferentially use applications from certain vendors, or use communication applications that integrate with their other software, such as office productivity software. In still other cases, for these or any other reasons, user contacts may fall out of the habit of using certain applications, or may not even check or run these applications often. Finally, even users who are not as overworked as in the example of FIG. 1 are still likely to face constraints of time and other resources, and thus by making collaboration smoother and more expeditious, the disclosed systems and methods can improve workflow, efficiency, and timeliness at the individual, group, and organizational levels.

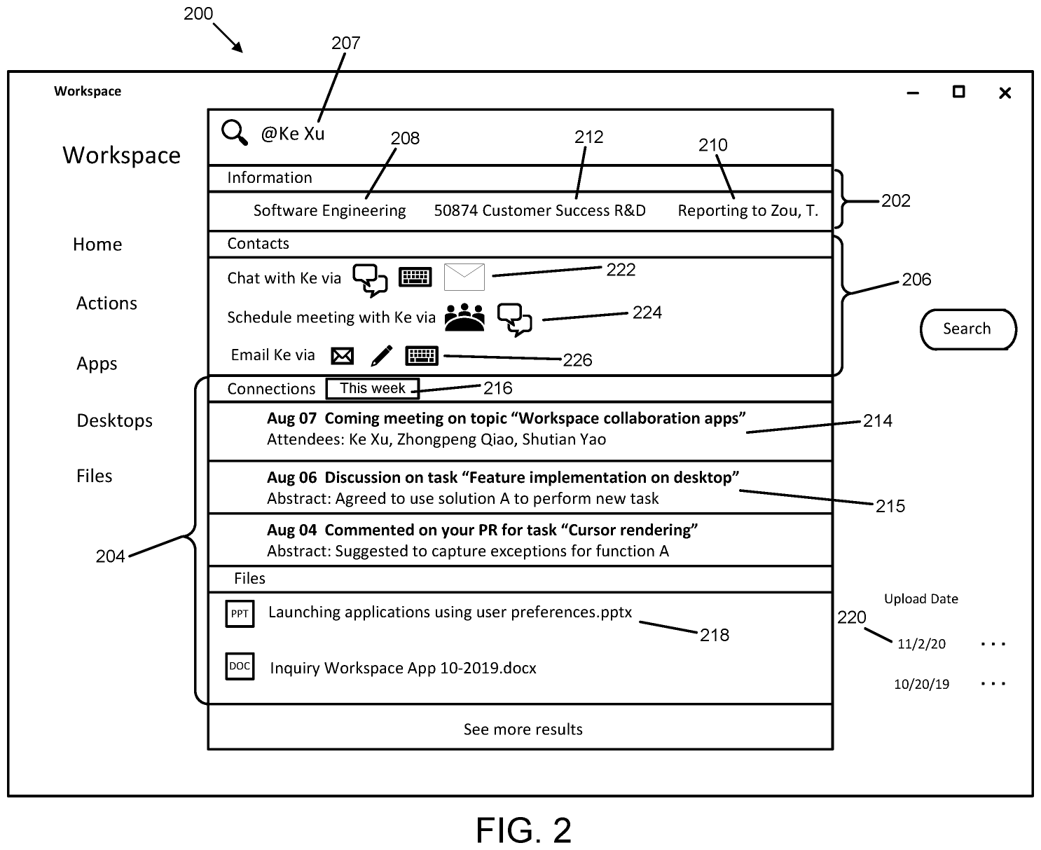

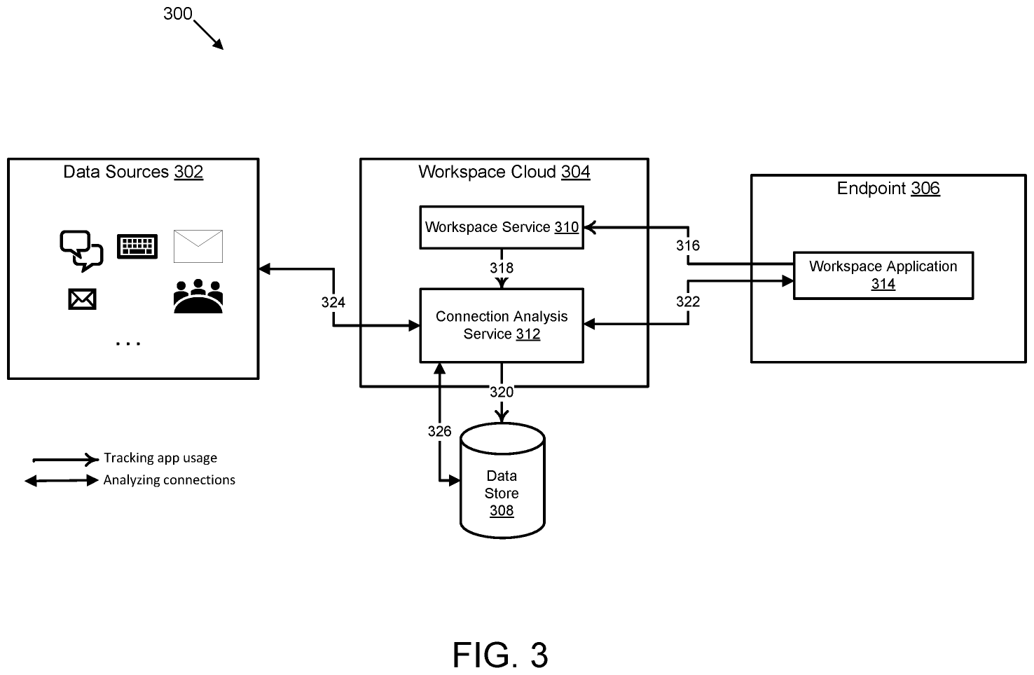

FIG. 2 illustrates a user contact's profile 200. In an example, the system (e.g., the connection analysis service 312 of the example of FIG. 3 below) may generate the contact profile 200, as disclosed herein, in response to a user's search for the contact, and may send the profile 200 to the user's client device to be displayed for the user. The contact profile 200 includes a contact's information 202, a connection history 204 with the contact, and a ranking 206 of the contact's usage frequency of numerous communication applications, in accordance with an example of the present disclosure.

The contact information 202 may include the contact's name 207 and credentials such as the contact's department 208, title, and supervisor 210. Contact information 202 may also include the contact's address 212, telephone number, email address, username for various communication and/or collaboration applications, and the like. In some examples, contact name 207 may be displayed in a search box that the user can use to search for the contact. For example, the user can input the contact's name 207, or an “@” symbol followed by the contact's username, in the search box. The system can then search a cloud data store for the contact, or can search distributed user information, such as individual endpoint devices.

The connection history 204 can include a listing of upcoming meetings between the user and the searched contact, such as an upcoming meeting 214, as well as previous meetings and/or conversations, such as a previous meeting 215. For example, a user can configure a recent period of time for the listing of previous meetings and/or conversations, for instance using a drop-down menu or control 216. In this example, the menu item 216 shows “This week” selected, and therefore the connection history 204 includes all the previous meetings and conversations that included the user and the searched contact within the previous week.

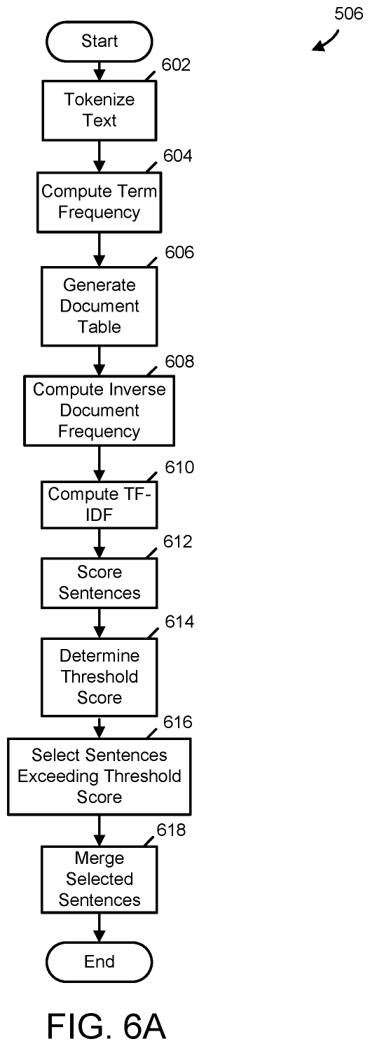

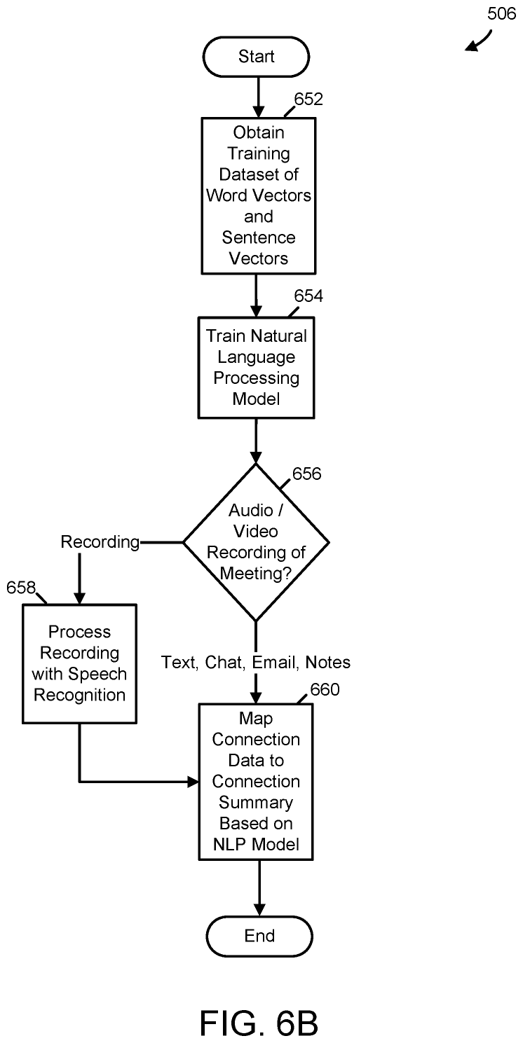

Moreover, each item in the connection history 204 includes a summary or abstract of the listed meeting and/or conversation. For example, the meeting 215 is summarized as “Abstract: Agreed to use solution A to perform new task.” The system can generate the summary or abstract using the methods disclosed herein, for example the method 506 of the examples of FIGS. 6A, based on term frequency-inverse document frequency (TF-IDF) analysis, and 6B, based on natural language processing (NLP). Likewise, the summary for the upcoming meeting 214 shows the planned attendees.

The connection history 204 can also include a listing of files that were exchanged between the user and the searched contact, such as the file 218. For example, the listed files may have been exchanged in the meetings and/or conversations listed in the connection history 204, or may have been exchanged independently (such as via a website or shared drive), and are not limited by the present disclosure. The connection history 204 may also include an upload or version date 220 for each file, or each version of a file.

The ranking 206 of the contact's usage frequency can include information about how often the searched contact uses various communication and collaboration applications. For example, the user can use this information to decide how best to reach the searched contact. In this example, the applications are displayed by type, such as messaging applications 222, meeting applications 224 (which may also include VoIP, video, and/or collaboration applications), and email applications 226. Moreover, within each type of communication or collaboration application, the individual applications are ranked by frequency of usage by the searched contact. For example, if the user wishes to send a chat message to a contact, the user can view the ranking 206 of the messaging applications 222. In an example, the user may choose the top-ranked one of the messaging applications 222, in order to have a high probability that the contact will read and respond to the chat message. In another example, the user may choose the highest-ranked among the messaging applications 222 that the user also uses regularly, in order to select a messaging application that both the user and the contact are prone to use.

The system can generate the ranking 206 based on usage data obtained from communication or collaboration services associated with the various applications, as disclosed herein. In this example, the applications are displayed as icons. In an example, the user can click on each icon in order to initiate a chat or meeting, or compose an email, to the contact, using the application represented by the icon. Alternatively or additionally, the applications can be listed in the ranking 206 by name, or be displayed in any other way, and are not limited by the present disclosure.

The contact profile generation systems and processes described herein can be implemented within a variety of computing resources. For instance, in some examples, the contact profile generation systems and processes are implemented within a browser and/or a browser extension. Moreover, in some examples, the systems and processes are implemented within a virtualization infrastructure, such as the HDX™ virtualization infrastructure commercially available from Citrix Systems of Fort Lauderdale, Fla., in the United States. In these examples, the contact profile generation systems and processes can be implemented within a workspace client application (also referred to as a digital workspace application), such as the Citrix Workspace™ application; a browser embedded within the workspace client application; a secure browser service, such as the Citrix Secure Browser™ service; a gateway appliance, such as the Citrix Application Delivery Controller™ (ADC); a virtualization agent, and/or other computing resources.

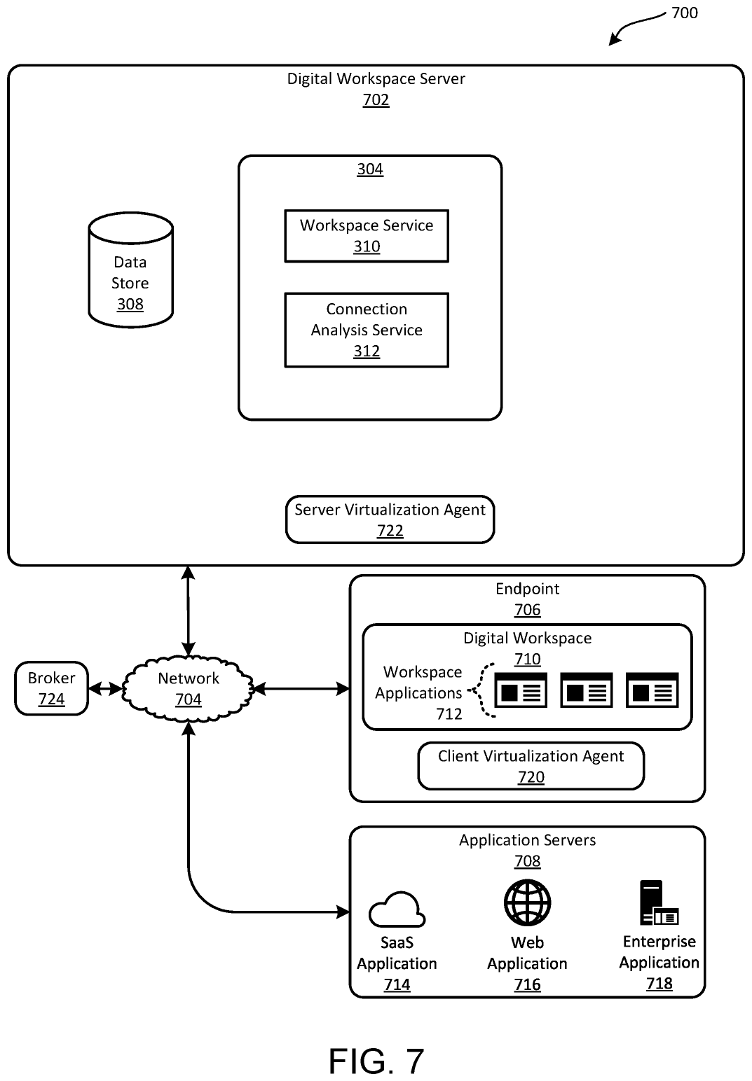

FIG. 3 is a block diagram illustrating a system 300 configured to generate a user contact profile, in accordance with an example of the present disclosure. As shown, the system 300 can include data sources 302, a workspace cloud 304, and an endpoint 306. The workspace cloud 304, for example hosted by digital workspace server 702 of FIG. 7 below, can include a workspace service 310 and a connection analysis service 312. The connection analysis service 312 can obtain and analyze usage data and connection history data from the data sources 302, the endpoint 306, and the data store 308, as described in this example. In addition, the connection analysis service 312 can generate a contact profile, such as the contact profile 200 of the example of FIG. 2. The contact profile can include a connection summary, which may be generated by the connection analysis service 312, as disclosed herein, for example in FIGS. 6A and 6B below.

The data sources 302 can include a plurality of collaboration services and/or communication and collaboration applications, such as the applications 222, 224, and 226 of the example of FIG. 2. In another example, the communication and collaboration applications may include messaging applications such as Slack, Skype, and Teams, video and collaboration applications such as Zoom, Skype, and Teams, email applications such as Outlook and Thunderbird, and/or any other applications. For example, the collaboration services can be cloud-based services associated with the communication and collaboration applications, while the applications themselves may execute locally on client devices of end users. The connection analysis service 312 may obtain connection history data from the collaboration services via application programming interfaces (APIs). In another example, the data sources 302 can include the applications executed on the client devices.

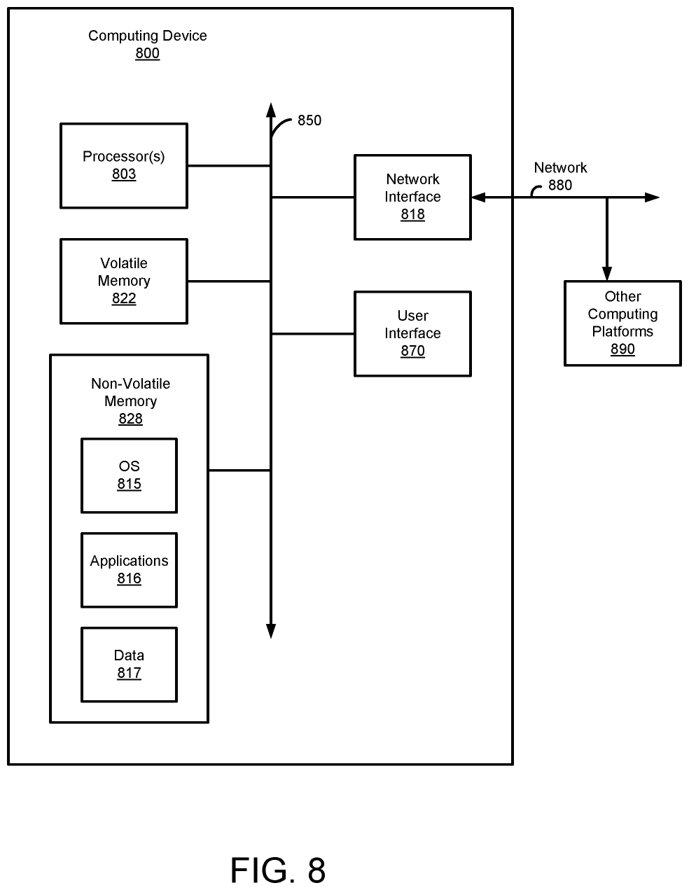

The endpoint device 306 can include a client device of an end user, such as the endpoint 706 of FIG. 7 or the client device 800 of the example of FIG. 8 below. The endpoint 306 may include a client device of the user who searches for a contact, as in the example of FIG. 2 above. In some examples, the endpoint 306 can include a client device of the searched contact, and/or a client device of any other user, and is not limited by the present disclosure. The endpoint 306 can execute a workspace application 314, and can implement the disclosed methods (for example, sending a contact search request to the workspace cloud 304, receiving a response, and rendering the contact profile result) via the workspace application 314 (also referred to as a workspace client application or a digital workspace application), such as the Citrix Workspace™ application; a browser embedded within the workspace client application; a secure browser service, such as the Citrix Secure Browser™ service; a gateway appliance, such as the Citrix Application Delivery Controller™ (ADC); a virtualization agent, and/or other computing resources. In some examples, the workspace client application or digital workspace application may itself execute at the endpoint, and/or may provide access to applications and/or data served or virtualized by the workspace cloud 304. An example of the workspace application 314 can include the digital workspace 710 of the example of FIG. 7.

In some examples, the connection analysis service 312 has two functional capabilities. First, the connection analysis service 312 can obtain a contact's communication and/or collaboration application usage history. For example, the connection analysis service 312 may retrieve this usage data from the workspace service 310, which may obtain the usage data from the contact's workspace application 314 at an endpoint 306. In another example, the connection analysis service 312 may obtain this usage data directly from communication and/or collaboration applications, such as those illustrated in the data sources 302, and/or from collaboration services via APIs exposed and implemented by the communication and/or collaboration applications. The connection analysis service 312 can then record the obtained usage data in the data store 308. The data store 308 can be implemented as, for example, a database. Likewise, when a user searches for a contact, the connection analysis service 312 can retrieve previously recorded usage data of the contact from the data store 308. The connection analysis service 312 can incorporate this retrieved usage data into the contact profile 200 in its response to the user.

In one example communication flow, as illustrated in FIG. 3, the workspace service 310 can retrieve 316 communication application usage data from the contact's workspace application 314 at the contact's endpoint 306. The connection analysis service 312 can then retrieve 318 the usage data from the workspace service 310, and can then store 320 the usage data in the data store 308.

As a second functionality, the connection analysis service 312 can receive and respond to a request for connection information (e.g., pertaining to previous connections between the user and the contact) from the endpoint 306 (e.g., from the workspace application 314). For example, in response to the user's search for the contact via the workspace application 314 at the endpoint 306, the workspace application 314 can request connection information from the connection analysis service 312 in the workspace cloud 304. The connection analysis service 312 can retrieve raw connection history data from the various data sources 302. The connection analysis service 312 can then analyze the retrieved data to prepare the connection history 204, and incorporate this into the contact profile 200 in its response to the user. In some examples, the connection analysis service 312 also obtains other information from the data store 308, for example the contact's information 202 and credentials, and the previously recorded communication application usage data, as described above.

In an example communication flow, as illustrated in FIG. 3, a user can search for a contact via the workspace application 314 at the endpoint 306, and the workspace application 314 can request 322 connection history information from the connection analysis service 312 in the workspace cloud 304. The connection analysis service 312 can then obtain 324 connection history data from the data sources 302 and obtain 326 additional information, including the contact's information 202 and credentials and the contact's communication application usage data 206, from the data store 308. In some examples, the connection analysis service 312 can also store 326 the connection history information in the data store 308.

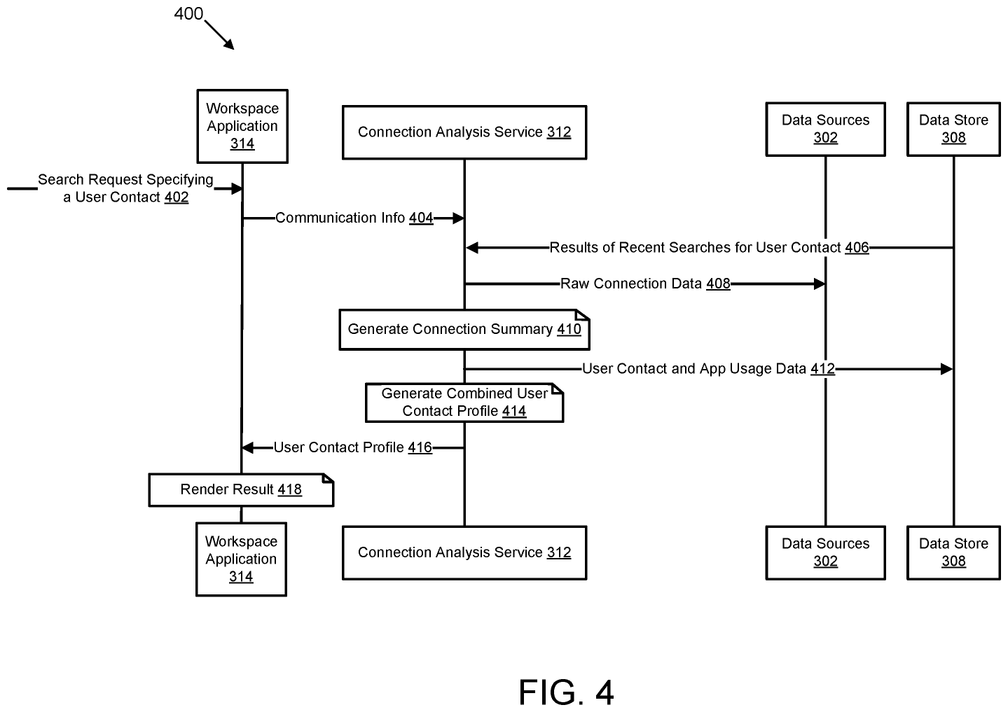

FIG. 4 is a communication flow diagram illustrating a method 400 for generating a user contact profile, in accordance with an example of the present disclosure. The steps of the method 400 may be performed by the workspace application 314, the connection analysis service 312, the data sources 302, and the data store or database 308 shown in FIG. 3. Alternatively or additionally, some or all of the steps of the method 400 may be performed by one or more other computing devices. The steps of the method 400 may be modified, omitted, and/or performed in other orders, and/or other steps added.

At step 402, the workspace application 314 may receive a search request specifying a user contact. The search request may include all or part of the contact's name, a username of the contact, or any other information that identifies the contact.

In response to the search request, at step 404, the workspace application 314 can trigger a request to the connection analysis service 312 for all communication related information.

At optional step 406, if the same contact has been previously searched in the recent past, the connection analysis service 312 can retrieve contact profile information from the data store 308, such as connection history data involving the contact, the contact's information 202 and credentials, and/or previously recorded communication application usage data involving the contact. In some examples, the connection analysis service 312 may use the contact profile information if it is available in the data store 308. Alternatively or additionally, the connection analysis service 312 may determine whether to use the contact profile information in the data store 308 based on the recency of stored information available. For example, the system may determine the stored information is sufficiently recent based on comparing the data's age to a threshold age, such as a week, a month, or six months, and/or based on another measure of recency, for example the data's age multiplied by the contact's average frequency of usage of communication applications. In an example, the system can determine the stored information's age by retrieving metadata, for example by looking up one or more file timestamps.

In some examples, the system can determine if sufficient contact profile information is available in the data store 308. If the stored contact profile information is sufficient, the connection analysis service 312 may use the stored information to generate the contact profile, and may then proceed directly to step 416, transmitting the contact profile to the workspace application 314. For example, the connection analysis service 312 may determine that the information available in the data store 308 is sufficient based on the amount, quality, and/or recency of the information. For example, the system may determine the amount of data is sufficient based on a threshold quantity of data, and/or based on having fewer than a threshold number of details missing. In another example, the system may determine the quality of data is sufficient based on the presence of one or more particularly important details, such as an identification of the application most frequently used by the contact, and/or based on a measure of statistical certainty, such as a number of data points used to determine the contact's frequency of usage. In yet another example, the system may determine the recency of data is sufficient based on various measures of recency, as described above.

In some examples, this determination may be made separately for the different parts of the combined contact profile 200, such as the contact's credentials and information 202, the usage data 206, the connection summary 204, and/or any other contact profile information. In this case, in various examples, the system may update part or all of the contact profile directly from the sources, as described in steps 406-412 below, and/or may simply use the data available from the data store 308. For example, the system may make an overall determination that the stored information is sufficient based on the combined contact profile as a whole, and/or on the combination of its parts, and may then accordingly continue to step 416 if the data is sufficient.

If insufficient contact profile information is available in the data store 308 from previous searches, the connection analysis service 312 can proceed to gather the information and assemble the contact profile. At step 408, the connection analysis service 312 retrieves raw connection data between the user and the searched contact from the data sources 302. For example, the connection analysis service 312 can retrieve previous meetings and/or conversations between the user and the searched contact, previous chat messages and emails, recordings and/or speech-recognition text of voice and video chats or meetings, as well as date, time, topic, and attendee information about upcoming meetings from the data sources 302. The raw connection data can also include dates and times associated with these previous and/or upcoming communications, files exchanged and metadata associated with the files, and text of chat messages, emails, meeting notes, and/or speech recognition or transcriptions of meetings or conversations. In various examples, the data sources 302 can include communication and collaboration applications, and/or cloud-based services associated with the applications.

At step 410, the connection analysis service 312 can generate the connection summary. For example, the connection analysis service 312 can apply TF-IDF analysis and/or an NLP process to generate a text summary for each previous connection in the historical connection data. In some examples, the connection analysis service 312 can use another method to generate the connection summary, such as supervised or unsupervised machine learning, and is not limited by the present disclosure. In some examples, the connection summary is generated by the workspace service 310, by another component of workspace cloud server 304, and/or by another computing device, and is not limited by the present disclosure.

In cases with TF-IDF analysis, the connection analysis service 312 or workspace server can tokenize the connection history text received in step 408, and compute TF-IDF values for individual terms in the text. For example, the connection analysis service 312 or workspace server can compute the TF-IDF value for a term t as a product of TF(t) and IDF(t), where TF(t) is a ratio of a number of occurrences of tin a document to the total number of terms in the document, and IDF(t) is the logarithm of a ratio of the total number of documents to the number of documents mentioning t. The connection analysis service 312 or workspace server can then sum the TF-IDF values for the terms in each phrase (e.g., each sentence) in the connection data to compute a phrase score for each phrase. The connection analysis service 312 or workspace server can then determine a threshold score, for example the mean or median score value among all the phrases analyzed. The connection analysis service 312 or workspace server can select those phrases (e.g., sentences) with scores exceeding the determined threshold score. The connection analysis service 312 or workspace server can then generate the connection summary by merging the selected phrases. Techniques of TF-IDF analysis are described further in the example of FIG. 6A below.

In cases with NLP, the connection analysis service 312 or workspace server can obtain a training dataset of word vectors and sentence vectors. The connection analysis service 312 or workspace server can then train an NLP model using the training dataset. If the data includes an audio or video recording of a meeting, the connection analysis service 312 or workspace server can then process the recording with speech recognition to obtain a text transcript of the meeting. The connection analysis service 312 or workspace server can then apply the NLP model to map the connection data to the connection summary. For example, the system may use the word and/or sentence vectors to determine clusters of semantically similar sentences, and then summarize each cluster, for example by replacing it with a representative sentence in the cluster. Techniques of NLP are described further in the example of FIG. 6B below.

At step 412, the connection analysis service 312 can retrieve the contact's application usage data, and/or the contact's basic information and credentials, that has been previously recorded in the data store 308. In some examples, retrieving the application usage data from the data store 308 is the default action, and thus the connection analysis service 312 retrieves the application usage data from the data store 308 when possible. Accordingly, in some cases, the connection analysis service 312 only retrieves the usage data from other sources periodically. For example, the connection analysis service 312 may retrieve the contact's usage data from the data store 308, but subsequently update the record in the data store 308 with additional usage data retrieved directly from communication and/or collaboration applications, such as those illustrated in the data sources 302, and/or from collaboration services via APIs. For example, the connection analysis service 312 may update the usage data in the data store 308 according to a regular update schedule. In another example, the connection analysis service 312 may obtain the usage data directly from the communication and/or collaboration applications when insufficient usage data is available in the data store 308, or when the usage data available in the data store 308 is older than a threshold age.

Alternatively or additionally, in some examples, at step 412, the connection analysis service 312 may obtain the usage data directly from the communication and/or collaboration applications, and/or from collaboration services via APIs. For example, the connection analysis service 312 may obtain the contact's usage data from the contact's workspace application at the contact's endpoint. In another example, the connection analysis service 312 may retrieve this usage data from the workspace service 310, which may obtain the usage data from the contact's workspace application. The connection analysis service 312 can then record the obtained usage data in the data store 308.

In an example, the system can track users' usage of various communication and/or collaboration applications, for example on a daily basis. The system can then generate a record of each user's application usage in a recent period. For example, the system may generate this record on a monthly basis, and can ignore and/or delete data older than one month.

For example, suppose that on day 1, User A used Slack and Teams to send messages, Teams to participate in a meeting, and Outlook to send email. On day 2, User A used Slack and Skype to send messages, Zoom to participate in a meeting, and Outlook to send email. On day 3, User A used Slack and Teams to send messages, Teams to participate in a meeting, and Outlook to send email. On day 4, User A used Slack and Teams to send messages, Teams to participate in a meeting, and Outlook to send email. In this example, the days on which User A used each application may be tracked and recorded in the data store 308, as illustrated in the following data structure.

```
{
  “name”:“User A”,
  “Contact”:[
    {
      “Catalog”:“message”,
      “data”:[
        “Slack”:4,
        “Teams”:3,
        “Skype”:1
      ]
    },
    {
      “Catalog”:“meeting”,
      “data”:[
        “Teams”:3,
        “Zoom”:1
      ]
    },
    {
      “Catalog”:“email”,
      “data”:[
        “Outlook”:4
      ]
    }
  ]
}
```

Based on this record, the system can aggregate the usage data to determine measures of usage frequency, for example the total number of times User A used each application over time, a ranking of usage frequency, and the like.

At step 414, the connection analysis service 312 can generate the combined contact profile, such as the contact profile 200 in the example of FIG. 2. For example, the connection analysis service 312 can combine the contact's credentials and information, the application rankings and/or usage data, the connection summary, and/or any other contact profile information to generate the combined contact profile. For example, the connection analysis service 312 may combine this information into a single formatted file or message, or may combine them into a human-readable, structured, or self-describing packet, such as HTML, XML, or JSON. In some examples, the combined contact profile may include information about its own presentation, for example, HTML, CSS, JavaScript, and the like, in addition to the content of the contact profile.

In some examples, if any information associated with the combined contact profile is unavailable, the connection analysis service 312 may generate the combined contact profile with the parts that are available. For example, if the searched contact happens to be a new hire within the user's organization, less information may be available about the contact. For example, the contact profile for a new hire might include the contact's credentials and basic information 202, while the ranking 206 of the contact's usage frequency of communication applications might include only the user's own preferences if insufficient data is available about the new hire, and the connection history 204 and file history are absent.

At step 416, the connection analysis service 312 can send the combined contact profile to the user's workspace application 314 as a response to the request received in step 402.

At step 418, the workspace application 314 can then render the contact profile result for the user, as illustrated, for example, in FIG. 2.

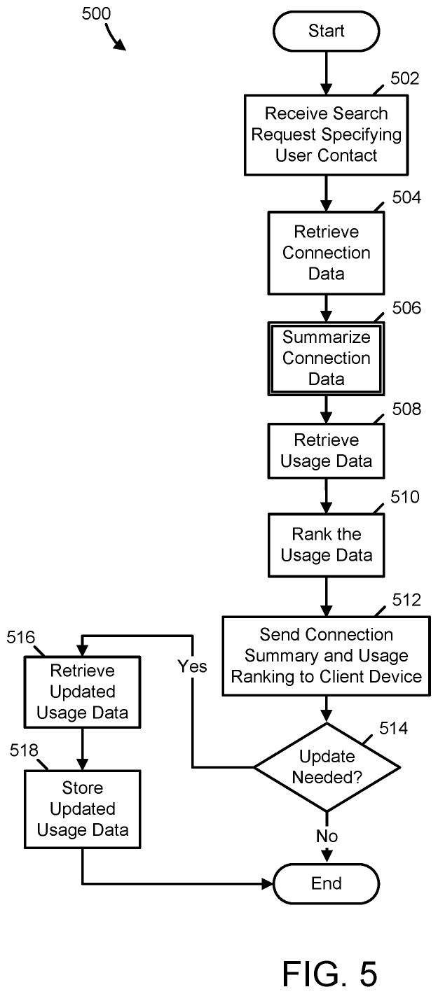

FIG. 5 is a flow diagram of a process 500 for generating a user contact profile, in accordance with an example of the present disclosure. In various examples, the process 500 may be implemented by a connection analysis service, which may execute on a workspace server, as in the example of FIG. 3 above. Alternatively or additionally, the process 500 may be executed by a client device, or may be implemented within a virtualization infrastructure, as described in the example of FIG. 7 below, and is not limited by the present disclosure.

As shown in FIG. 5, the generating a user contact profile process starts with the connection analysis service receiving 502 a search request specifying a user contact. The search request may include any information that identifies the contact, such as a name or username of the contact.

Next, the connection analysis service can retrieve 504 connection data. For example, if the same contact has been previously searched in the recent past, the connection analysis service can retrieve contact profile information from a data store (e.g., the data store 308 of FIG. 3), which can include connection history data involving the user and the searched contact. In another example, the connection analysis service can retrieve date, time, topic, and attendee information about upcoming meetings directly from data sources (e.g., the data sources 302 of FIG. 3). The raw connection data can include dates and times associated with these previous and/or upcoming communications, files exchanged and metadata associated with the files, and text of chat messages, emails, meeting notes, and/or speech recognition or transcriptions of meetings or conversations. In various examples, these data sources can include communication and collaboration applications, and/or cloud-based services associated with the applications.

Next, the connection analysis service can summarize 506 the connection data. The system can generate the summary or abstract using the methods disclosed herein. For example, further details of step 506 is given in the examples of FIGS. 6A, based on TF-IDF analysis, and 6B, based on NLP.

Next, the connection analysis service can retrieve 508 usage data. In some examples, the connection analysis service retrieves the usage data from the data store (e.g., the data store 308 of FIG. 3) by default. If insufficient usage data is available in the data store, the connection analysis service may update the usage data directly from one or more data sources, such as the contact's endpoint and/or communication and collaboration applications, as described in step 516 below.

Next, the connection analysis service can rank 510 the usage data. For example, the connection analysis service can rank the applications within each type (e.g., chat or messaging applications, voice, video, or meeting applications, and email applications) by frequency of the contact's usage. For example, the connection analysis service can rank the frequency of the contact's usage averaged over some recent time period, or over the entire record of usage data.

Next, the connection analysis service can send 512 the connection summary and usage ranking to the endpoint or client device of the user who searched for the contact. For example, the connection analysis service can combine the contact's credentials and information 202, the application usage rankings 206 and/or usage data, the connection listings and summaries 204, and/or any other contact profile information in the combined contact profile. The endpoint or client device can render the combined contact profile for the user, as illustrated in FIG. 2.

The connection analysis service can also determine 514 whether an update is needed to the usage data. For example, the system may determine whether an update is needed based on comparing the data's age to a threshold age or another measure of recency, based on comparing the quantity of data to a threshold quantity, and/or based on the presence of key details in the data. In some examples, the determination 514 can include a determination of updates needed to other contact profile data, such as the contact's credentials and information 202, the connection summary 204, and/or any other contact profile information, as described in step 406 of FIG. 4 above. If no update is needed, the process 500 can end.

If an update is needed, the connection analysis service can retrieve 516 updated usage data from communication and/or collaboration applications, such as those illustrated in the example of FIG. 3, and/or from collaboration services via APIs. For example, the connection analysis service may obtain the contact's usage data from a client workspace application and/or from the contact's endpoint. In another example, the connection analysis service may retrieve this usage data from the digital workspace and/or the workspace server, which may have obtained the usage data from the contact's endpoint. The connection analysis service can then store 518 the updated usage data in the data store, e.g. a database. In some examples, retrieving 516 and/or storing 518 the updated data can include retrieving and/or storing other updated contact profile data, such as updates to the contact's credentials and information 202, the connection summary 204, and/or any other contact profile information, as described in step 406 of FIG. 4 above. After storing 518 the updated data, the process 500 may then end.

FIG. 6A is a flow diagram of a process 506 for using TF-IDF analysis to generate a user contact profile, in accordance with an example of the present disclosure. In this example, the process 506 may provide additional details of step 506 of the process 500 for generating a user contact profile in FIG. 5. In various examples, the process 506 may be implemented by a connection analysis service, which may execute on a workspace server, as in the example of FIG. 3 above. Alternatively or additionally, the process 506 may be executed by a client device, or may be implemented within a virtualization infrastructure, as described in the example of FIG. 7 below, and is not limited by the present disclosure.

In operation 602, the connection analysis service or workspace server can tokenize the connection history text received from the data sources (e.g., the data sources 302 of FIG. 3) and/or the data store (e.g., the data store 308 of FIG. 3). For example, the connection analysis service or workspace server can remove irrelevant and/or unimportant words.

In operation 604, the connection analysis service or workspace server can compute a term frequency TF(t) for the terms tin the connection history. For example, the connection analysis service or workspace server can compute TF(t) for each tokenized term or word tin the text. In some examples, the connection analysis service or workspace server can generate a matrix or vector TF(t) as a ratio of a number of occurrences of the term tin a document to the total number of terms or words in the document. That is,

$$TF ( t ) = \frac{Number of times term t appears in a document}{number of terms in the document} .$$

In some examples, the denominator of TF(t) may be the total number of terms or words in the document including repetitions of each term, such that TF(t) may be normalized to sum to one over all terms t. In some examples, TF(t) may be normalized in other ways, such as using binary or raw counts of each term t, and is not limited by the present disclosure.

In operation 610, the connection analysis service or workspace server can compute TF-IDF values for individual terms in the connection history text. For example, the connection analysis service or workspace server may first compute an inverse document frequency value, IDF(t), for each tokenized term or word tin the text. The IDF value may correspond to a measure of uniqueness or rarity of term or word t. In some examples, the connection analysis service or workspace server can generate a matrix or vector IDF(t) as a logarithm of a ratio of the total number of documents to the number of documents mentioning t. That is,

$$IDF ( t ) = log ( \frac{Total number of documents}{Number of documents containing term t} ) .$$

For example, the documents used in computing IDF(t) may correspond to all the available connection history data, across all users and contacts, during a recent time period, or over all time. In another example, the documents used may correspond to individual conversations, meetings, chats, emails, or email threads between the user and the searched contact.

The connection analysis service or workspace server can then compute the TF-IDF value for term t as a product of TF(t) and IDF(t). For example, the connection analysis service or workspace server can compute a TF-IDF value, TF-IDF(t), for each tokenized term or word tin the text. In some examples, the connection analysis service or workspace server can generate a matrix or vector TF−IDPF(t)=TF(t)·IDF(t).

In operation 612, the connection analysis service or workspace server can score phrases in the connection history. For example, the phrases may be individual sentences in the connection history text. For example, the connection analysis service or workspace server can sum the TF-IDF(t) values for the terms tin each respective phrase (e.g., each sentence) in the connection data to compute a phrase score for the respective phrase.

In operation 614, the connection analysis service or workspace server can then determine a threshold score for including the phrases in the connection summary. For example, the connection analysis service or workspace server may determine the threshold score as the mean or median score value among all the phrases analyzed, or among all the phrases (e.g., sentences) in the current document. In another example, the connection analysis service or workspace server may take into account the length of the connection summary when setting the threshold score. For example, the connection analysis service or workspace server may determine that the connection summary should have a length of L phrases or sentences. The connection analysis service or workspace server may then set the threshold score to approximately the Lth-highest score in the document being analyzed, for example to a value between the Lth-highest and (L+1)-highest scores. In another example, the connection analysis service or workspace server may use a hybrid of these methods, for example by choosing the connection summary length L as a constant plus a term proportional to the square root of the total number S of phrases or sentences in the document, L=L₀+L₁ \sqrt{S}.

In operation 616, the connection analysis service or workspace server can select those phrases (e.g., sentences) with scores exceeding the determined threshold score.

In operation 618, the connection analysis service or workspace server can then generate the connection summary by merging the selected phrases. For example, the connection analysis service or workspace server can generate the connection summary to include every phrase (e.g., sentence) with a score exceeding the determined threshold score. The phrases or sentences may be included in the same sequence as in the original document.

In another example, the connection analysis service or workspace server may abstract, condense, or modify the individual phrases. For example, the connection analysis service or workspace server may also apply TF-IDF analysis or any other technique to condense and/or combine the individual phrases before including in the connection summary. In another example, the connection analysis service or workspace server may use artificial intelligence, machine learning (e.g., supervised learning), and/or NLP to improve the grammatical or logical flow or coherency of the merged phrases. The use of NLP and machine learning to generate a user contact profile is described further in the example of FIG. 6B.

FIG. 6B is a flow diagram of a process 506 for using NLP to generate a user contact profile, in accordance with an example of the present disclosure. In this example, process 506 may provide additional details of step 506 of process 500 for generating a user contact profile in FIG. 5. In various examples, process 506 may be implemented by a connection analysis service, which may execute on a workspace server, as in the example of FIG. 3 above. Alternatively or additionally, the process 506 may be executed by a client device, or may be implemented within a virtualization infrastructure, as described in the example of FIG. 7 below, and is not limited by the present disclosure.

In operation 652, the connection analysis service or workspace server can obtain a training dataset of word vectors and/or sentence vectors. For example, the connection analysis service or workspace server can obtain a training dataset of words together with vectors representing the words, and a training dataset of sentences together with vectors representing the sentences. In another example, the connection analysis service or workspace server can apply an NLP, word embedding (such as the Word2vec technique of Google LLC, a Continuous Bag-of-Words model, a Continuous Skip-Gram model, a Global Vectors for Word Representation model, or Latent Semantic Analysis), and/or sentence embedding technique to assign words and sentences to vectors in a training dataset of text. The word vectors may be chosen to indicate semantic similarity between respective words, and the sentence vectors may be chosen to indicate semantic similarity between respective sentences. For example, the sentence vectors may represent similarity among the words within the sentences, or among the sentences as a whole. In some examples, the system can use another machine learning (e.g., supervised learning) approach, such as key phrase or key sentence classification.

In operation 654, the connection analysis service or workspace server can then train an NLP model. For example, the connection analysis service or workspace server can train an NLP, word embedding (e.g., a model related to Word2vec, a Continuous Bag-of-Words model, a Continuous Skip-Gram model, a Global Vectors for Word Representation model, or Latent Semantic Analysis), and/or sentence embedding model to recognize words and sentences of the training dataset obtained in operation 652. The training may train the model to assign the words to word vectors and/or the sentences to sentence vectors. Alternatively, in some examples, the system may reuse an existing word and/or sentence embedding.

In operation 656, the connection analysis service or workspace server can then determine whether the connection history data includes an audio or video recording, e.g. of a meeting, or whether the data includes text, e.g. chat messages, email, and/or notes of a meeting or conversation. If the connection history data includes text, chat messages, email, and/or notes, the connection analysis service or workspace server may proceed to operation 660.

In operation 658, if the data includes an audio or video recording of a meeting, the connection analysis service or workspace server can then process the recording with speech recognition to obtain a text transcript of the meeting.

In operation 660, the connection analysis service or workspace server can then apply the NLP model to map the connection data to the connection summary. For example, the system can apply an NLP, word embedding, and/or sentence embedding model to determine word vectors and/or sentence vectors based on the connection data. The system may use the word and/or sentence vectors to determine clusters of semantically similar sentences in a respective document (e.g., a conversation, meeting, or email) of the connection data. The system can then summarize each cluster of similar sentences, for example by replacing it with a single representative sentence from the cluster. For example, the representative sentence can be chosen based on its vector's proximity to the mean or centroid of the vectors in the cluster.

In another example, the system uses non-negative matrix factorization (e.g., with a document-term matrix) to determine features representing respective documents in the connection data. In some examples, the system can use another machine learning (e.g., supervised learning) approach, such as key phrase or key sentence classification.

### Computer System Configured to Generate a User Contact Profile

FIG. 7 is a block diagram of an example system 700 for generating a user contact profile, in accordance with an example of the present disclosure. The system 700 includes a digital workspace server 702 that is capable of analyzing how a user, associated with an endpoint 706, interacts with applications provided by one or more application servers 708. The user's association with the endpoint 706 may exist by virtue of, for example, the user being logged into or authenticated to the endpoint 706. While only one endpoint 706 and three example application servers 708 are illustrated in FIG. 7 for clarity, it will be appreciated that, in general, the system 700 is capable of analyzing interactions between an arbitrary number of endpoints and an arbitrary number of application servers. The digital workspace server 702, the endpoint 706, and the application servers 708 communicate with each other via a network 704. The network 704 may be a public network (such as the Internet) or a private network (such as a corporate intranet or other network with restricted access). Other examples may have fewer or more communication paths, networks, subcomponents, and/or resources depending on the granularity of a particular implementation. For example, in some implementations at least a portion of the application functionality is provided by one or more applications hosted locally at an endpoint. Thus references to the application servers 708 should be understood as encompassing applications that are locally hosted at one or more endpoints. It should therefore be appreciated that the examples described and illustrated herein are not intended to be limited to the provision or exclusion of any particular services and/or resources.

The digital workspace server 702 is configured to host the workspace cloud 304 (which may include the workspace service 310 and the connection analysis service 312), and the server virtualization agent 722. The digital workspace server 702 may comprise one or more of a variety of suitable computing devices, such as a desktop computer, a laptop computer, a workstation, an enterprise-class server computer, a tablet computer, or any other device capable of supporting the functionalities disclosed herein. A combination of different devices may be used in certain examples. As illustrated in FIG. 7, the digital workspace server 702 includes one or more software programs configured to implement certain of the functionalities disclosed herein as well as hardware capable of enabling such implementation.

As noted above, in certain examples the endpoint 706 can be a computing device that is used by the user. Examples of such a computing device include but are not limited to, a desktop computer, a laptop computer, a tablet computer, and a smartphone. The digital workspace server 702 and its components are configured to interact with a plurality of endpoints. In an example, the user interacts with a plurality of workspace applications 712 that are accessible through a digital workspace 710, which can serve as a workspace client application 314 discussed above with reference to FIG. 3. The user's interactions with the workspace applications 712 and/or the application servers 708 may be tracked, monitored, and analyzed by the workspace service 310. Any microapps can be made available to the user through the digital workspace 710, thereby allowing the user to view information and perform actions without launching (or switching context to) the underlying workspace applications 712. The workspace applications 712 can be provided by the application servers 708 and/or can be provided locally at the endpoint 706. For instance, the example workspace applications 712 include a SaaS application 714, a web application 716, and an enterprise application 718, although any other suitable exiting or subsequently developed applications can be used as well, including proprietary applications and desktop applications. To enable the endpoint 706 to participate in a virtualization infrastructure facilitated by the broker computer 724 and involving the server virtualization agent 722 as discussed herein, the endpoint 706 also hosts the client virtualization agent 720.

The broker computer 724 is configured to act as an intermediary between the client virtualization agent 720 and the server virtualization agent 722 within the virtualization infrastructure. In some examples, the broker computer 724 registers virtual resources offered by server virtualization agents, such as the server virtualization agent 722. In these examples, the broker computer 724 is also configured to receive requests for virtual resources from client virtualization agents, such as the client virtualization agent 720, and to establish virtual computing sessions involving the client virtualization agent 720 and the server virtualization agent 722.

### Computing Device

FIG. 8 is a block diagram of a computing device configured to implement various systems and processes in accordance with examples disclosed herein.

The computing device 800 includes one or more processor(s) 803, volatile memory 822 (e.g., random access memory (RAM)), non-volatile memory 828, a user interface (UI) 870, one or more network or communication interfaces 818, and a communications bus 850. The computing device 800 may also be referred to as a client device, computing device, endpoint device, computer, or a computer system.

The non-volatile (non-transitory) memory 828 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 870 can include a graphical user interface (GUI) (e.g., controls presented on a touchscreen, a display, etc.) and one or more input/output (I/O) devices (e.g., a mouse, a keyboard, a microphone, one or more speakers, one or more cameras, one or more biometric scanners, one or more environmental sensors, and one or more accelerometers, one or more visors, etc.).

The non-volatile memory 828 stores an OS 815, one or more applications or programs 816, and data 817. The OS 815 and the application 816 include sequences of instructions that are encoded for execution by processor(s) 803. Execution of these instructions results in manipulated data. Prior to their execution, the instructions can be copied to the volatile memory 822. In some examples, the volatile memory 822 can include one or more types of RAM and/or a cache memory that can offer a faster response time than a main memory. Data can be entered through the user interface 870 or received from the other I/O device(s), such as the network interface 818. The various elements of the device 800 described above can communicate with one another via the communications bus 850.

The illustrated computing device 800 is shown merely as an example client device or server and can be implemented within any computing or processing environment with any type of physical or virtual machine or set of physical and virtual machines that can have suitable hardware and/or software capable of operating as described herein.

The processor(s) 803 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be include one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor(s) 803 can be analog, digital or mixed. In some examples, the processor(s) 803 can be one or more local physical processors or one or more remotely-located physical processors. A processor including multiple processor cores and/or multiple processors can provide functionality for parallel, simultaneous execution of instructions or for parallel, simultaneous execution of one instruction on more than one piece of data.

The network interfaces 818 can include one or more interfaces to enable the computing device 800 to access a computer network 880 such as a Local Area Network (LAN), a Wide Area Network (WAN), a Personal Area Network (PAN), or the Internet through a variety of wired and/or wireless connections, including cellular connections and Bluetooth connections. In some examples, the network 880 may allow for communication with other computing devices 890, to enable distributed computing. The network 880 can include, for example, one or more private and/or public networks over which computing devices can exchange data.

In described examples, the computing device 800 can execute an application on behalf of a user of a client device. For example, the computing device 800 can execute one or more virtual machines managed by a hypervisor. Each virtual machine can provide an execution session within which applications execute on behalf of a user or a client device, such as a hosted desktop session. The computing device 800 can also execute a terminal services session to provide a hosted desktop environment. The computing device 800 can provide access to a remote computing environment including one or more applications, one or more desktop applications, and one or more desktop sessions in which one or more applications can execute.

The processes disclosed herein each depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

1. A server computer system, the server computer system comprising:
a memory; and
at least one processor coupled to the memory and configured to:
receive, from a client device, a search request specifying a user contact;
retrieve connection data associated with the user contact from one or more collaboration services via one or more application programming interfaces (APIs);
summarize the connection data to obtain a connection summary;
retrieve, from a data store, usage data specifying usage by the user contact of one or more communication applications;
rank the usage data of the one or more communication applications to obtain a usage ranking; and
send the connection summary and the usage ranking to the client device.

2. The server computer system of claim 1, wherein the one or more communication applications comprise a plurality of communication applications.

3. The server computer system of claim 2, wherein:
the plurality of communication applications pertain to a plurality of types of communication applications, the plurality of types including:
applications configured to transmit chat messages comprising text;
applications configured to transmit voice and/or video; and
applications configured to transmit electronic mail; and
to rank the usage data of the one or more communication applications comprises to rank a respective set of communication applications pertaining to a respective type of the communication applications.

4. The server computer system of claim 1, wherein to rank the usage data of the one or more communication applications comprises to rank the one or more communication applications by a frequency of usage by the user contact.

5. The server computer system of claim 1, wherein to summarize the connection data comprises to perform a term frequency-inverse document frequency (TF-IDF) analysis.

6. The server computer system of claim 5, wherein to summarize the connection data further comprises:
to compute a phrase score for a respective phrase in the connection data based on a sum of TF-IDF values for a plurality of terms in the respective phrase; and
to generate the connection summary including at least a first phrase having a first phrase score above a threshold value.

7. The server computer system of claim 1, wherein to summarize the connection data comprises to map, based on a natural language processing model, the connection data to the connection summary.

8. The server computer system of claim 1, wherein the at least one processor is further configured to:
retrieve, from a second client device, updated usage data specifying a number of usages by the user contact of a respective communication application during a recent time period; and
update the usage data in the data store to include the updated usage data.

9. The server computer system of claim 1, wherein the connection data includes one or more historical conversations of the user contact utilizing the one or more collaboration services.

10. The server computer system of claim 1, wherein a respective collaboration service of the one or more collaboration services is associated with a respective communication application.

11. A method, the method comprising:
receiving, from a client device by a server, a search request specifying a user contact;
retrieving connection data associated with the user contact from one or more collaboration services via one or more application programming interfaces (APIs);
summarizing the connection data to obtain a connection summary;
retrieving, from a data store, usage data specifying usage by the user contact of one or more communication applications;
ranking the usage data of the one or more communication applications to obtain a usage ranking; and
sending the connection summary and the usage ranking to the client device, wherein the client device renders the connection summary and the usage ranking.

12. The method of claim 11, wherein:
the one or more communication applications comprise a plurality of communication applications;
the plurality of communication applications pertain to a plurality of types of communication applications, the plurality of types including:
applications configured to transmit chat messages comprising text;
applications configured to transmit voice and/or video; and
applications configured to transmit electronic mail; and
ranking the usage data of the one or more communication applications comprises ranking a respective set of communication applications pertaining to a respective type of the communication applications.

13. The method of claim 11, wherein summarizing the connection data comprises performing a term frequency-inverse document frequency (TF-IDF) analysis.

14. The method of claim 11, wherein summarizing the connection data further comprises:
computing a phrase score for a respective phrase in the connection data based on a sum of TF-IDF values for a plurality of terms in the respective phrase; and
generating the connection summary including at least a first phrase having a first phrase score above a threshold value.

15. The method of claim 11, wherein summarizing the connection data comprises mapping, based on a natural language processing model, the connection data to the connection summary.

16. The method of claim 11, further comprising:
retrieving, from a second client device, updated usage data specifying a number of usages by the user contact of a respective communication application during a recent time period; and
updating the usage data in the data store to include the updated usage data.

17. A non-transitory computer readable medium storing executable sequences of instructions, the sequences of instructions comprising instructions to:
receive, from a client device, a search request specifying a user contact;
retrieve connection data associated with the user contact from one or more collaboration services via one or more application programming interfaces (APIs);
summarize the connection data to obtain a connection summary;
retrieve, from a data store, usage data specifying usage by the user contact of a plurality of communication applications;
rank the usage data of the plurality of communication applications to obtain a usage ranking; and
send the connection summary and the usage ranking to the client device.

18. The non-transitory computer readable medium of claim 17, wherein to summarize the connection data comprises to perform a term frequency-inverse document frequency (TF-IDF) analysis.

19. The non-transitory computer readable medium of claim 18, wherein to summarize the connection data further comprises:
to compute a phrase score for a respective phrase in the connection data based on a sum of TF-IDF values for a plurality of terms in the respective phrase; and
to generate the connection summary including at least a first phrase having a first phrase score above a threshold value.

20. The non-transitory computer readable medium of claim 17, wherein to summarize the connection data comprises to map, based on a natural language processing model, the connection data to the connection summary.
